(19) United States
(12) Patent Application Publication
(10) Pub. No.: US 2007/0121021 A1
(43) Pub. Date: May 31, 2007

(54) Display device with acoustic noise suppression

(76) Inventors: John W. Kaehler, Lake Bluff, IL (US); Sen Yang, Palatine, IL (US); Zhiming Zhuang, Kildeer, IL (US); Shaohai Chen, Libertyville, IL (US)

Correspondence Address: MOTOROLA INC, 600 NORTH US HIGHWAY 45, ROOM AS437, LIBERTYVILLE, IL, 60048-5343, US

(21) Appl. No.: 11/289,120

(22) Filed: Nov. 29, 2005

(51) Int. Cl. G02F 1/1335

(52) U.S. Cl. 349/12

(57) ABSTRACT

Disclosed herein are a plurality of displays for an electronic device including a display layer (102, 104), a light guide layer (108), and a damping material layer (110) coupled between the light guide layer and the display layer. The display layer in one embodiment is a liquid crystal display layer, but other types of display layers may be used. The light guide layer may serve as a back light for the display layer, and may be between approximately 0.05 mm and 2 mm in thickness. Devices described herein include at least one interposed layer of acoustic and/or mechanical energy absorbing material, also referred to herein as damping material, between the display layer susceptible to vibration, and a hard layer near the display layer. The damping material as described herein may reduce the audio noise. The energy absorbing layer may take the form of an audio energy absorbing sheet interposed between layers of the display.

### TECHNICAL FIELD

The present disclosure relates to a display for an electronic device and more particularly to acoustic noise suppression for a display.

### BACKGROUND

As more features are added to mobile communication devices, the convenience of the technology has made wireless communication increasingly popular. In addition to voice communication, wireless communication devices such as cellular telephones, may receive and transmit with higher data transmission rates. For example, pictures and even videos may be displayed on a mobile communication device. Moreover, many icons can be displayed with more applications available to run on mobile communication devices. Larger displays provide for improved viewing of pictures and videos. Accordingly, large displays have become a common central feature of mobile communication devices.

A wide variety of mobile communication devices have been developed. Such devices include, for example, cellular phones, pagers, radios, personal digital assistants (PDAs), notebook or laptop computers incorporating wireless modems, mobile data terminals, application specific gaming devices, video gaming devices incorporating wireless modems, etc.

As mobile communication device technology has continued to improve, the devices, and in particular, cellular telephones, have become increasingly smaller with the displays occupying a larger percentage of at least one face of the device. Even though larger in area, display devices have become lighter and thinner, with the glass used in display devices becoming correspondingly thinner as well. Moreover, mobile communication device designs typically place the earpiece above the display, therefore users will place the display next to one of their ears when engaged in a call. As device designs and technology have advanced, an annoying tone emanating from display devices may be heard. The new designs for mobile communication devices may afford the desired feature of a display occupying a relatively large proportion of the face of the mobile communication device, however the noise from the display into the user's ear may detrimentally increase. Audio noise may be caused by glass vibration, and as mentioned above, may become more pronounced as glass thicknesses continue to diminish. In short, this effect is caused by the changes in applied voltages between the top and bottom layers of glass as different pixels in the display are excited. A resultant mechanical effect of the display voltages is to cause small vibrations in the audio range. That is, an oscillatory force is set up which can cause the glass layers to flex in the normal direction. When the glass is free to vibrate without contacting a hard surface, the audio level is generally low. The audio effect is greatly enhanced however when the glass comes in contact with a hard object, which is the case with layers of components forming the displays, e.g. the light guide, touch panel, protection lens and the like.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows a display for an electronic device according to an embodiment including a composite backlight;

FIG. 2 is a more detailed view of the composite backlight of FIG. 1;

FIG. 3 shows a schematic depiction of a surface with small protrusions to effect acoustic damping in a display; and

FIG. 4 shows a display for an electronic device according to another embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In a liquid crystal type display, the liquid crystal layer incorporates glass surfaces. As mobile communication device manufacturers move toward smaller designs, thinner displays will require thinner sheets of glass. Electric voltages are applied to the top and bottom layers of the glass surfaces to excite the pixels of the liquid crystal display. Under the influence of the applied voltages, the glass layers may flex. The rate at which the pixels are excited is quite high, approximately 60 kHz. If free to vibrate the thinner glass can produce an audio tone when colliding with the other surfaces of the display that can be annoying to the user.

Disclosed herein are a plurality of displays for an electronic device. The displays include a display layer, a light guide layer, and a damping material layer coupled between the light guide layer and the display layer. The display layer in one embodiment is a liquid crystal display layer, but other types of display layers may be used. The light guide layer may serve as a back light for the display layer, and may be between approximately 0.05 mm and 2.0 mm in thickness and preferably between 0.05 mm and 0.6 mm in thickness.

Described herein are devices including at least one interposed layer of acoustic and/or mechanical energy absorbing material, also referred to herein as damping material, or acoustic dampening material, between the display layer susceptible to vibration, and a hard layer near the display layer. The damping material as described herein may reduce the audio noise. The energy absorbing layer may take the form of an audio energy absorbing sheet interposed between layers of the display.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The words “a” or “an” means at least one.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

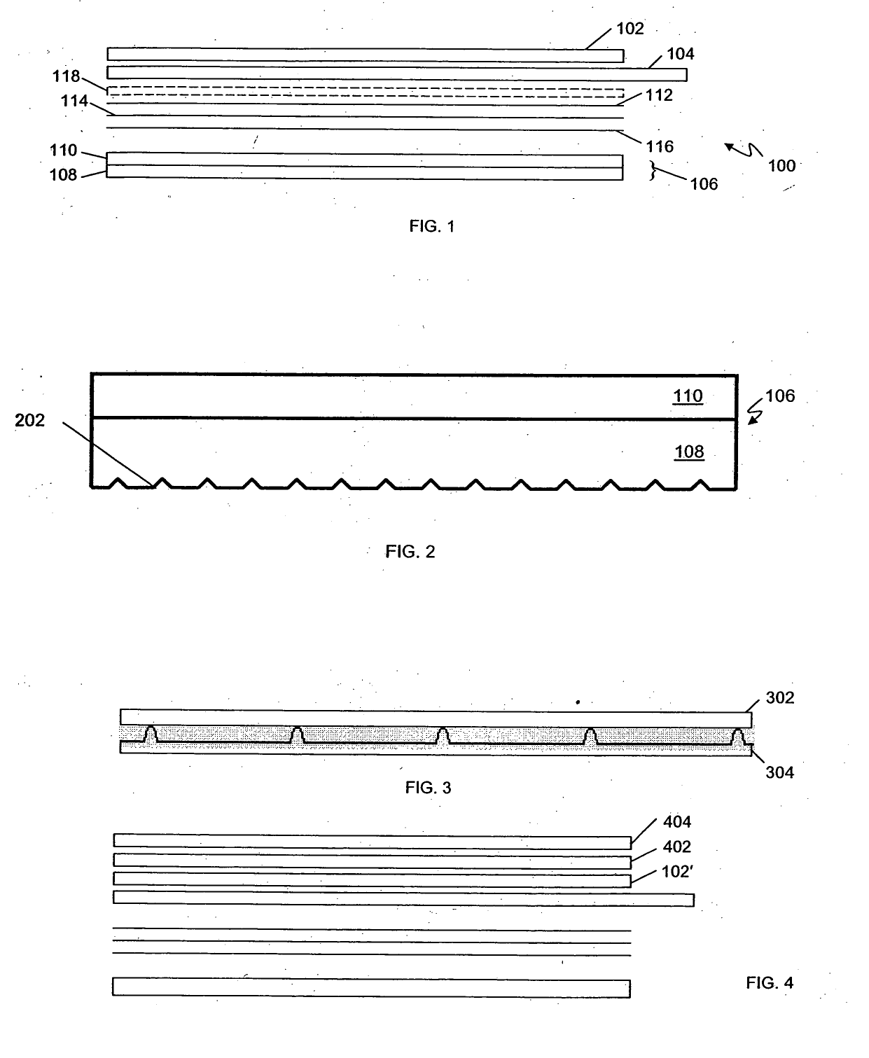

FIG. 1 shows a display 100 for an electronic device including the disclosed damping layer according to an embodiment. Many of the layers shown in display 100 are common to displays and are shown here for illustrative purposes. Display 100 may include a liquid crystal display formed with a glass biplane having two glass sheets 102 and 104. Liquid crystal material may be sandwiched between glass sheets 102 and 104. The display typically also includes sheets of polarizing material.

Transparent electrodes deposited on the inner surfaces of glass sheets 102 and 104 adjacent the liquid crystal material may receive applied voltages to excite pixels of the display. The transparent electrodes may also be fabricated on separate layers of material rather than on the glass sheets themselves. Typically the applied voltages change over short time scales, to provide a sufficient refresh rate for the display. As previously mentioned, frequencies on the order of 60 kHz can be expected.

The applied voltages create electrostatic forces acting on one or both of the glass sheets 102 and 104. Due to the thinness of the sheets, the electrostatic forces may flex the sheets. Oscillations of the sheets, caused by the rapidly changing applied voltages, may result.

A backlight assembly 106 may supply illumination for display 100. As shown, backlight assembly 106 may include two layers, a light guide layer 108 and the disclosed damping material layer 110. The light guide layer may also be referred to herein as a light guide. Typically a light guide is made from a transparent colorless solid material with a predetermined optical index, for example, a refractive index of approximately 1.5 in one exemplary embodiment. Other material layers in the display may also have predetermined optical indices.

The described interposed damping material layer 110 may have the form of a sheet of absorbing material, a film of absorbing material applied on a surface, or any other configuration of a layer. The interposed damping material layer may be made from a transparent colorless material having a refractive index closely matching that of the light guide layer. In this exemplary embodiment, closely matching means having a refractive index difference of less than 0.2 Closely matching the refractive indices of the materials making up the two layers may improve optical transmission across the interface between the light guide layer and the damping material layer, and reduce optical transmission losses at the interface.

The damping material layer may also have a significant optical index mismatching that of the display in one embodiment. In another embodiment the there is a significant air gap, or void, between the dampening material layer and the display. The air gap or void is a separation distance between the dampening material layer and the display.

The damping material may be chosen for its ability to absorb acoustic and mechanical energy. For example the damping material may be made of polycarbonate or PMMA acrylic. It is understood that any damping materials that serve the same purpose as described herein are included in this discussion.

As will be discussed in more detail below, damping material may be used in other parts of the display 100. For example, several layers of material may be interposed between the backlight assembly 106 and the glass sheet 104 to enhance the optical characteristics and behavior of the display. A pair of dual brightness enhancement films 112 and 114 may serve to collimate the light and reflect light of a certain polarization component back into the light guide for improved display brightness. An additional diffuser sheet 116 may be positioned to distribute light from the light guide more evenly. One or more of these layers may be comprised of damping material, or there may be a layer of damping material interposed among them, and their surfaces may be configured to provide damping effects.

The backlight assembly 106 may include the light guide 108 without damping material layer 110. Instead, a damping material layer may be interposed between other layers of the display as discussed above. For example, a damping material layer 118, shown in dashed outline in FIG. 1 may be interposed between dual brightness enhancement film 112 and glass sheet 104.

FIG. 2 is a more detailed view of the backlight 106 of FIG. 1, hereinafter referred to as a composite backlight. In particular, FIG. 2 shows detail of the interface 202 between light guide layer 108 and damping material layer 110. The composite backlight 106 may be referred to herein as a two layer soft top light guide. Damping material layer 110 can provide a resilient, acoustic and/or mechanical energy absorbing soft top layer.

In still another embodiment, the suppression of acoustic noise may be accomplished by fabricating one or more of the interior surfaces of the display with small protrusions. FIG. 3 shows an exemplary schematic depiction of a surface with small protrusions to effect acoustic damping in a display. In this way, the area of contact between layers of the display can be reduced, and hence the mechanical coupling for transmission of energy between layers may be reduced. A configuration of two surfaces, 302 and 304 with small protrusions on one of the surfaces is shown in the exemplary embodiment of FIG. 3. The drawing of FIG. 3 is not to scale, but is illustrative. In a particular embodiment, for example, film 112 of FIG. 1 may instead be replaced with a brightness enhancement film fabricated with bumps similar to the exemplary depiction 304 of FIG. 3. Surface 302 of FIG. 3 may then correspond to a surface of the glass sheet 104 of FIG. 1. If the surface 304 is the damping layer 110, the there is an air gap between surface 304 and the dampening material layer 110 and the light guide layer 108 to prevent light leakages from the bumps.

FIG. 4 shows a display for an electronic device according to another embodiment. In the embodiment of FIG. 4, a damping material layer 402 may be placed on top of an upper glass sheet 102′ of the liquid crystal display. A display lens 404 may cover the layer of damping material. In one embodiment the upper glass sheet 102 may be a polarizer layer. Alternatively, a touch screen may cover the layer of damping material. Thus, in an embodiment with a touch screen, the damping material layer may be coupled between the display layer and the touch screen.

In one alternative embodiment, the display may also comprise a front light that provides illumination from the front of the display layer. The front light, is a first layer and may have an optical index substantially mismatched from that of a second layer, which is the dampening material layer. A third layer is a display layer which in this embodiment is a glass layer. It is to be understood that that the display layer may be glass or other material such as plastic or the like.

The damping material described herein may lessen or eliminate audible nose from larger displays of devices. The damping material may be coupled to the display glass in any interposed position to eliminate its contact with hard surfaces and suppress otherwise resultant vibrations.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A display comprising:
a display layer;
a light guide layer having a thickness of between approximately 0.05 millimeters and approximately 2 millimeters and having a predetermined optical index; and
a damping material layer coupled between the light guide layer and the display layer, the damping material having an optical index substantially matching that of the light guide layer, and there is an air gap or significant optical index mismatching that of the display.

2. The display of claim 1, further comprising:
a plurality of other layers of the display;
wherein a first of the plurality of other layers is coupled with the damping material layer.

3. The display of claim 1 wherein the predetermined optical index is an index of refraction of substantially 1.5.

4. The display of claim 1 wherein the damping material layer has substantially 95% transmittivity.

5. The display of claim 1 wherein a surface of the damping material comprises small protrusions.

6. The display of claim 5 further comprising:
a plurality of other layers;
wherein a first of the plurality of other layers is coupled with the damping material layer, and the small protrusions of the surface of the damping material effect an air gap between the damping material and the first of the plurality of other layers.

7. The display of claim 1 wherein the damping layer is comprised of a substance from the group consisting of polycarbonate and PMMA acrylic.

8. The display of claim 1 wherein the light guide layer comprises an outer surface of the display.

9. The display of claim 1 wherein the display is a component of a mobile communication device.

10. The display of claim 1 wherein the display is a liquid crystal display.

11. A display, comprising:
a first layer having a hard surface and a predetermined optical index;
a second layer being a damping material layer coupled with the first layer; and
a third layer having a hard surface coupled with the second layer.

12. The display of claim 11, wherein the first layer is a front light, which has an optical index substantially mismatched from that of the second layer.

13. The display of claim 11, comprising an air gap between the first layer and the second layer.

14. The display of claim 11 wherein the first layer and the third layer comprise a touch pad.

15. The display of claim 12 wherein the light guide layer has a thickness of between approximately 0.05 millimeters and 2 millimeters

16. The display of claim 11 wherein the second layer is comprised of a substance from the group consisting of polycarbonate and PMMA acrylic.

17. The display of claim 11 wherein a surface of the second layer comprises small protrusions.

18. The display of claim 11 wherein the liquid crystal display is a component of a mobile communication device.

19. The display of claim 11 wherein the display is a liquid crystal display.

20. A display comprising:
a light guide layer having a thickness of between approximately 0.05 millimeters and 2 millimeters;
a display layer; and
a damping material layer coupled with the display layer;
wherein the damping material comprises an outer surface of the display layer.

21. The display of claim 20 wherein the light guide layer has a predetermined optical index and wherein the damping layer has an optical index substantially mismatching the optical index of the light guide layer, or there is an air gap between display and light guide.

22. The display of claim 20 wherein the display is a component of a mobile communication device.

23. The display of claim 20 wherein the display is a liquid crystal display.
